(19) United States
(12) Patent Application Publication
(10) Pub. No.: US 2026/0195647 A1
(43) Pub. Date: Jul. 9, 2026

(54) INFORMATION PROCESSING DEVICE, METHOD, AND STORAGE MEDIUM

(71) Applicant: NEC Corporation, Tokyo (JP)

(72) Inventors: Kensuke WAGATA, Tokyo (JP); Yuki KOSAKA, Tokyo (JP)

(73) Assignee: NEC Corporation, Tokyo (JP)

(21) Appl. No.: 19/407,402

(22) Filed: Dec. 3, 2025

(30) Foreign Application Priority Data
Jan. 9, 2025 (JP) 2025-003176

(51) Int. Cl. G06N 20/00

(52) U.S. Cl. CPC G06N 20/00

(57) ABSTRACT

The information processing device 1X is an AI based device to support a decision making and includes an acquisition means 20X, a calculation means 22X, a selection means 23X, and a generation means 24X. The acquisition means 20X is configured to acquire a plurality of sets each including a sample and a label. The calculation means 22X is configured to calculate, for each of the plurality of sets, accuracy of the label based on a difference between the label and a predicted result of the label predicted from the sample paired with the label. The selection means 23X is configured to select a set to be used for generating pseudo data from the plurality of sets, based on the accuracy. The generation means 24X is configured to generate the pseudo data, based on the selected set.

### INCORPORATION BY REFERENCE

This application is based upon and claims the benefit of priority from Japanese Patent Application No. 2025-003176, filed on Jan. 9, 2025, the disclosure of which is incorporated herein in its entirety by reference.

### TECHNICAL FIELD

The present disclosure relates to a technical field of an information processing device, a method, and a storage medium related to a generation process of pseudo data.

There is a technique of augmenting training data by data augmentation. For example, Patent Literature 1 discloses a system that performs machine learning of a neural network and executes a data augmentation method of a learning data set used for the machine learning of the neural network.
Patent Literature 1: Wo 2022/097709 A1

### SUMMARY

When pseudo data indicating a set of a sample to be input to a machine learning model and a label indicating a correct answer to be output by the machine learning model is generated by data augmentation, there is a problem that reliability of the label included in the pseudo data is lowered.

In view of the above described problem, an object of the present disclosure is to provide an information processing device, a method, and a program capable of suitably generating pseudo data.

In an example aspect of the present disclosure, there is provided an information processing device including:
an acquisition means for acquiring a plurality of sets each including a sample and a label;
a calculation means for calculating, for each of the plurality of sets, accuracy of the label based on a difference between the label and a predicted result of the label predicted from the sample paired with the label;
a selection means for selecting a set to be used for generating pseudo data from the plurality of sets, based on the accuracy; and
a generation means for generating the pseudo data, based on the selected set.

In an example aspect of the present disclosure, there is provided a method including:
acquiring a plurality of sets each including a sample and a label;
calculating, for each of the plurality of sets, accuracy of the label based on a difference between the label and a predicted result of the label predicted from the sample paired with the label;
selecting a set to be used for generating pseudo data from the plurality of sets, based on the accuracy; and
generating the pseudo data, based on the selected set.

In an example aspect of the present disclosure, there is provided a program executed by a computer, the program causing the computer to:
acquire a plurality of sets each including a sample and a label;
calculate, for each of the plurality of sets, accuracy of the label based on a difference between the label and a predicted result of the label predicted from the sample paired with the label;
select a set to be used for generating pseudo data from the plurality of sets, based on the accuracy; and
generate the pseudo data, based on the selected set.

An example advantage according to the present disclosure is to suitably generate pseudo data.

### BRIEF DESCRIPTION OF THE DRAWINGS

FIG. 1 illustrates a schematic configuration of a pseudo data generation system.

FIG. 2 illustrates a hardware configuration of the pseudo data generation device.

FIG. 3 is a graph schematically illustrating a probability density of a sample with respect to a confidence score of class 1.

FIG. 4 is a diagram schematically illustrating a relationship between a predicted label and a distribution of samples.

FIG. 5 is an example of functional blocks of the pseudo data generation device.

FIG. 6 is a table illustrating association between a set of a sample and a label and the label accuracy.

FIG. 7 illustrates a specific example of correction of the label accuracy.

FIG. 8 is an exemplary flowchart to be executed by the pseudo data generation device.

FIG. 9 is an example of functional blocks of the pseudo data generation device that does not perform machine learning of the label predictor.

FIG. 10 is an example of a block diagram of the information processing device.

FIG. 11 illustrates an example of the flowchart of the process executed by the information processing device.

### EXAMPLE EMBODIMENT

Hereinafter, example embodiments of an information processing device, a method, and a storage medium will be described with reference to the drawings.

### First Example Embodiment

### (1) System Configuration

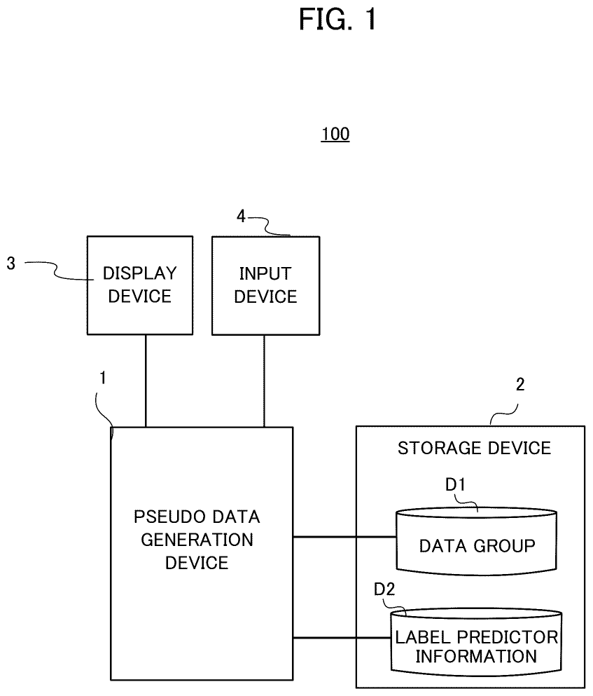

FIG. 1 illustrates a schematic configuration of a pseudo data generation system 100. The pseudo data generation system 100 generates pseudo data of time series data for machine learning by data augmentation. The pseudo data generation system 100 mainly includes a pseudo data generation device 1, a storage device 2 that stores a data group D1, a display device 3, and an input device 4.

The pseudo data generation device 1 performs data augmentation of the data group D1 that is training data of a machine learning model, and generates pseudo data corresponding to intermediate data of any two pieces of data included in the data group D1. The pseudo data generation device 1 may display information to be presented to a user of the pseudo data generation system 100 by the display device 3, or may receive a user's input (so-called external input) by the input device 4.

The storage device 2 is a memory that stores various types of information necessary for processing of the pseudo data generation device 1, and functionally includes the data group D1 and label predictor information D2.

The data group D1 is data for “N” (N is an integer of 2 or more) records used for machine learning of the machine learning model, and each record is a set (pair) of a sample that is data representing motion of a target and a label indicating correctness or incorrectness of the motion represented by the related sample. In other words, the data group D1 is training data for N records in a case where a sample for input to the machine learning model and a label indicating a correct answer to be output by the machine learning model are set as one record. For example, the data group D1 is training data of the machine learning model for inferring correctness or incorrectness of the motion. The motion in this case is, for example, rehabilitation exercise, sports exercise, or any other motion. Hereinafter, for convenience of description, description will be made on the assumption that a subject of motion is a person, but the subject of motion is not limited to a person, and may be any moving body such as an animal and a robot. The data group D1 is also used as training data for training a label predictor to be described later.

The sample may be, for example, a sequence of coordinate values representing sequence of positions of a joint (skeleton) of a person at respective time steps, or may be a moving image (that is, RGB values for each pixel) in which a person who moves is captured at respective time steps. The sample representing the sequence of positions of the joint (skeleton) at respective time steps is a tensor having a size of “number of channels (number of dimensions of coordinate space) ×number of joints ×number of time steps”, and the sample that is the moving image is a tensor having a size of “number of channels (RGB) ×vertical resolution ×horizontal resolution ×number of time steps”. The label is, for example, a binary value representing correctness or incorrectness of motion. The label is not necessarily a binary value, and in a case where incorrect motion is classified into a plurality of classes, the label is a value for identifying a class representing correct motion and a plurality of classes representing incorrect motion.

The label predictor information D2 is information necessary for configuring the label predictor, and includes a parameter determined by machine learning of the label predictor executed by the pseudo data generation device 1 using the data group D1. The label predictor is a model obtained by machine-learning a relationship between a sample and a label predicted from the sample. In the present example embodiment, the label predictor is machine-learned to output a predicted value (also referred to as a “predicted label”) of a label related to an input sample when the sample is input. The label predictor may be any deep learning model having a neural network architecture, or may be any statistical model such as a linear regression model. The label predictor information D2 includes, for example, a parameter related to an architecture for configuring the label predictor, a parameter obtained by machine learning, and the like. In a case where the label predictor is a neural network, the label predictor information D2 includes various parameters (including hyperparameters) such as a layer structure, a neuron structure of each layer, the number of filters and a filter size in each layer, and a weight of each element of each filter. Before execution of machine learning of the label predictor, an initial value of the parameter of the label predictor may be stored in the storage device 2 as the label predictor information D2.

The storage device 2 may be an external storage device such as a hard disk connected to or incorporated in the pseudo data generation device 1, or may be a storage medium such as a portable flash memory. The storage device 2 may be a server device that performs data communication with the pseudo data generation device 1. The storage device 2 may include a plurality of devices.

The display device 3 displays information, based on control of the pseudo data generation device 1. Examples of the display device 3 include a display, a projector, and the like. When receiving a display signal supplied from the pseudo data generation device 1, the display device 3 displays information based on the received display signal.

The input device 4 is an interface that receives the user's input that is the external input based on an operation of the user using the pseudo data generation system 100, and examples of the input device 4 include a touch panel, a button, a keyboard, a voice input device, and the like. The input device 4 supplies an input signal generated based on the user's input to the pseudo data generation device 1.

The configuration of the pseudo data generation system 100 illustrated in FIG. 1 is an example, and various changes may be made to the configuration. For example, the pseudo data generation device 1, the storage device 2, the display device 3, and the input device 4 may be integrally configured by any combination. The pseudo data generation system 100 may include a sound output device such as a speaker. The pseudo data generation device 1 may include a plurality of devices. In this case, the plurality of devices configuring the pseudo data generation device 1 exchange information necessary for executing processing allocated in advance between the plurality of devices.

### (2) Hardware Configuration

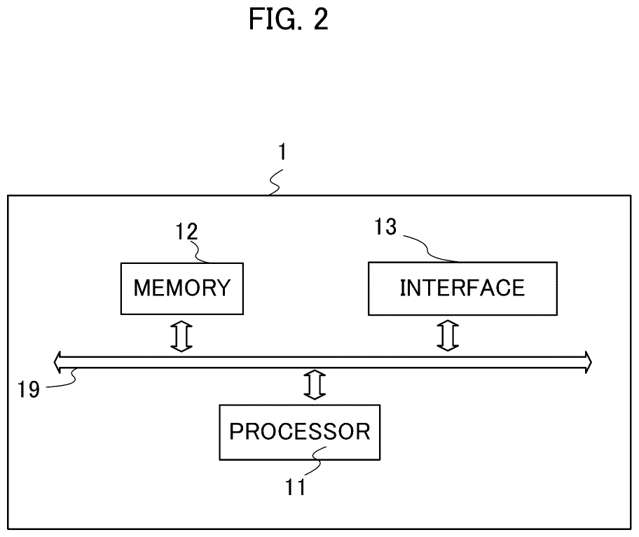

FIG. 2 illustrates a hardware configuration of the pseudo data generation device 1. The pseudo data generation device 1 includes, as hardware, a processor 11, a memory 12, and an interface 13. The processor 11, the memory 12, and the interface 13 are connected to one another via a data bus 19.

The processor 11 execute a program stored in the memory 12 to perform a predetermined process. The processor 11 is one or more processors such as a CPU (Central Processing Unit), a GPU (Graphics Processing Unit), and a TPU (Tensor Processing Unit). The processor 11 may be configured by plural processors. The processor 11 is an example of a computer.

The memory 12 is configured by volatile or non-volatile memories such as a RAM (Random Access Memory) and a ROM (Read Ony Memory). The memory 12 stores a program for the pseudo data generation device 1 to perform various processes. The memory 12 is used as a working memory, and temporarily stores information and the like acquired from the storage device 2. The memory 12 may function as the storage device 2. The storage device 2 may function as the memory 12 of the pseudo data generation device 1. The program executed by the pseudo data generation device 1 may be stored a storage medium other than the memory 12.

The interface 13 is one or more interfaces for electrically connecting the pseudo data generation device 1 and another device. These interfaces may include a wireless interface such as a network adapter for wirelessly transmitting and receiving data to and from the other device, or may include a hardware interface for connecting to the other device by a cable or the like.

A hardware configuration of the pseudo data generation device 1 is not limited to the configuration illustrated in FIG. 2. For example, the pseudo data generation device 1 may include at least one of the display device 3 or the input device 4. The pseudo data generation device 1 may be connected to or may incorporate a sound output device such as a speaker.

(3) Outline of pseudo data generation processing

An outline of pseudo data generation processing executed by the pseudo data generation device 1 will be described. Schematically, the pseudo data generation device 1 calculates accuracy of a label, based on a difference between a predicted label output by the label predictor by inputting each sample to the label predictor, after training of the label predictor, and a label (also referred to as an “actual label”) related to each sample. Then, the pseudo data generation device 1 selects data to be used for generating pseudo data, based on the calculated accuracy of the label (also referred to as “label accuracy P”). As a result, the pseudo data generation device 1 generates pseudo data having a high reliability label by selectively using only the data with the high reliability label.

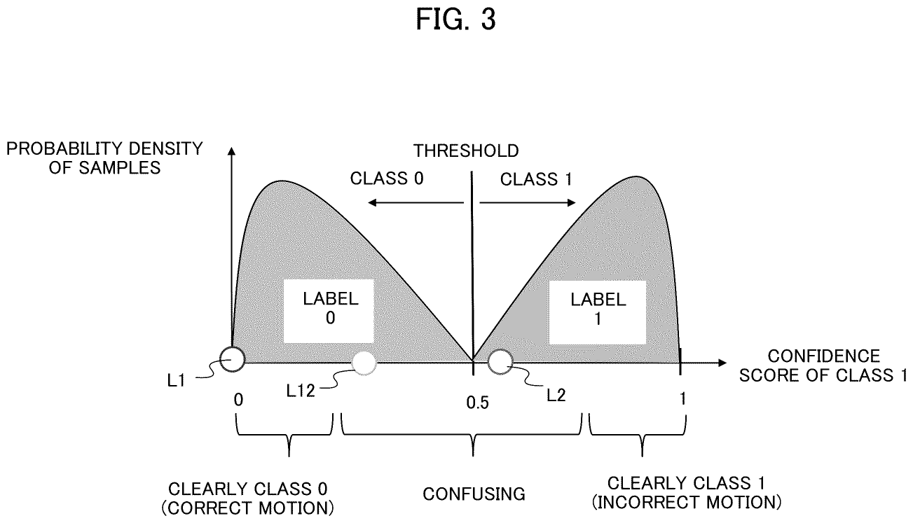

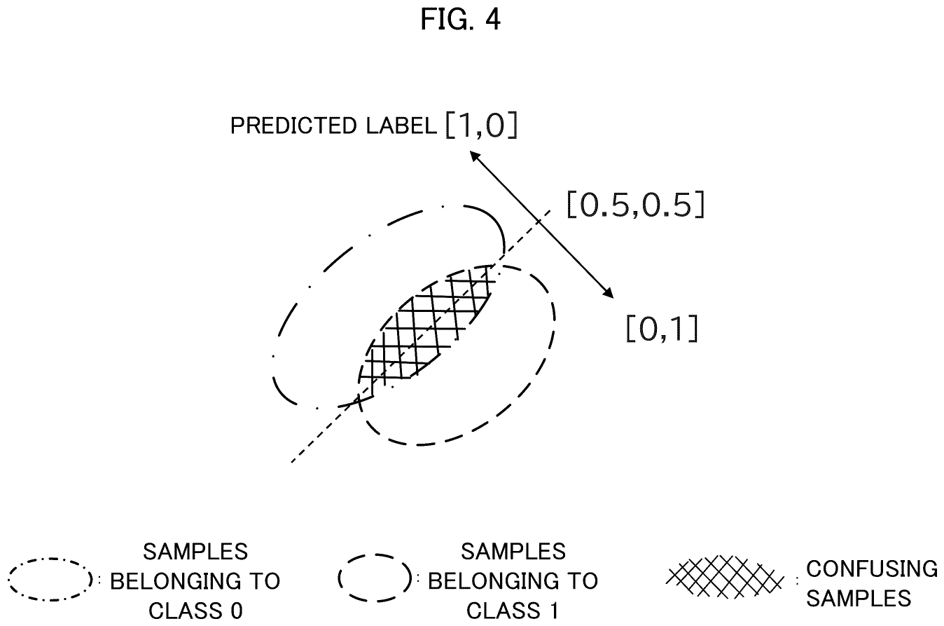

Here, an effect of selecting data to be used for generating pseudo data based on the label accuracy P will be supplementarily described with reference to FIGS. 3 and 4.

FIG. 3 is a graph schematically illustrating a probability density of a sample with respect to a confidence score of class 1 in a case where a label is a binary value taking either “0” representing “class 0” or “1” representing “class 1”. The “confidence score of class 1” indicates a confidence degree of a worker that a label set by an annotation work is class 1, and has a value range of 0 to 1. A sample whose confidence score of class 1 is less than a threshold (here, 0.5) is given label 0, and a sample whose confidence score of class 1 is equal to or more than the threshold 0.5 is given label 1. Then, a sample group in which the confidence score of class 1 is around 0 is a sample group that is clearly classified into class 0, and a sample group in which the confidence score of class 1 is around 1 is a sample group that is clearly classified into class 1. On the other hand, a sample group in which the confidence score of class 1 is around the threshold 0.5 is a sample group in which determination of the class is confusing.

As illustrated in FIG. 3, in general, it is difficult to give reliable labels to all the generated samples, and a confidence score of a label for a sample in which whether motion is correct is confusing is close to 0.5. In addition, even in samples of labels representing the same class, there is a sample whose class classification is clear and a sample whose class classification is confusing.

Then, since a label of a sample whose class classification is confusing has a low confidence score with respect to a value of label actually given, pseudo data having an inaccurate label is generated when data augmentation is performed using such data. For example, when pseudo data is generated by linear interpolation using a sample of class 0 in which the confidence score of class 1 is around 0 (see a circle L1) and a sample of class 1 in which the confidence score of class 1 is around 0.5 (see a circle L2), a label of the pseudo data is 0.5. On the other hand, since an average of the confidence score of class 1 of the samples that are a source of this pseudo data is around 0.25 (see a circle L12), the label of the pseudo data should originally be set to a value around 0.25. Therefore, the label of this pseudo data is inaccurate.

As described above, in order to generate pseudo data having an accurate label, it is necessary not to use data whose class classification is confusing. In consideration of the above, the pseudo data generation device 1 sets the label accuracy P according to a difference between a predicted label output by the label predictor and a related actual label, and selects data for generating pseudo data using the set label accuracy P.

FIG. 4 is a diagram schematically illustrating a relationship between a predicted label and a distribution of samples. Here, the predicted label represents a set of confidence (0to 1) of class 0 and confidence (0 to 1) of class 1, and a label of class 0 is denoted as [1, 0] and a label of class 1 is denoted as [0, 1]. A distribution of samples classified into class 0 is indicated by a one-dot chain line ellipse, and a distribution of samples classified into class 1 is indicated by a dotted line ellipse. In this case, a sample whose classification is confusing has a predicted label around [0.5, 0.5] (see broken line), and has a large difference from an actual label [1, 0] or [0, 1]. Therefore, the pseudo data generation device 1 sets the label accuracy P lower as the difference between the predicted label output by the label predictor and the related actual label is larger, and selects data for generating pseudo data using the set label accuracy P.

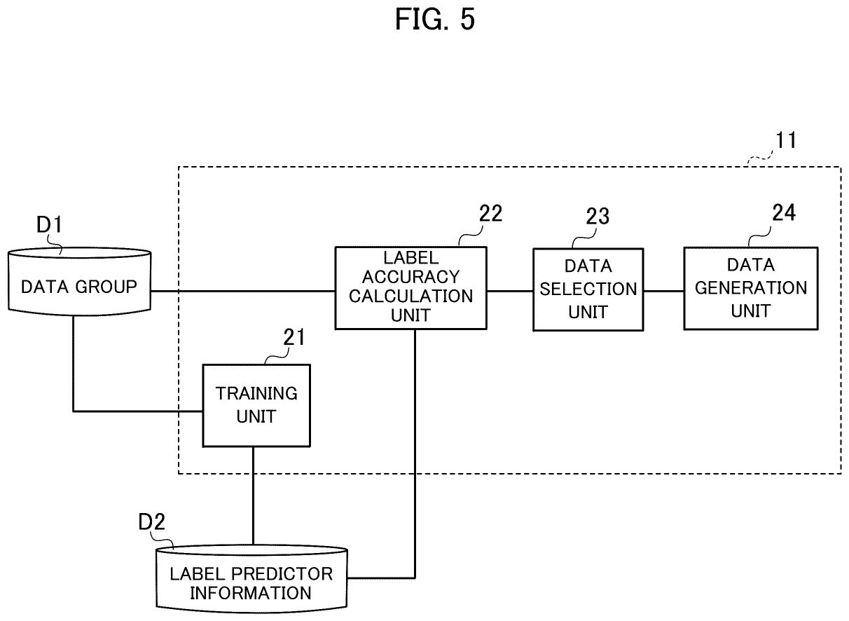

FIG. 5 is an example of functional blocks of the pseudo data generation device 1. As illustrated in FIG. 5, a processor 11 of the pseudo data generation device 1 functionally includes a training unit 21, a label accuracy calculation unit 22, a data selection unit 23, and a data generation unit 24. While blocks that exchange data with each other are connected by a solid line in FIG. 5, a combination of the blocks that exchange data with each other is not limited to this. The same applies to diagrams of other functional blocks described later.

The training unit 21 performs machine learning of the label predictor, based on a set of a sample and a label extracted from the data group D1. In this case, the training unit 21 determines a parameter of the label predictor in such a way that an error (loss) between a predicted result output from the label predictor when a sample is input to the label predictor and a label related to the input sample is minimized. The loss in this case may be a cross entropy, or may be a value determined by any other loss function. An algorithm for determining the parameter described above in such a way as to minimize the loss may be any learning algorithm used in machine learning such as gradient descent and back propagation. Then, the training unit 21 stores the label predictor information D2 including the determined parameter of the label predictor in the storage device 2.

The training unit 21 may perform machine learning of the label predictor using all the N records of the data group D1, or may perform machine learning of the label predictor using some of the N records. In the latter case, the record of the data group D1 acquired by the training unit 21 and the record of the data group D1 acquired by the label accuracy calculation unit 22 may be divided in such a way as not to overlap each other. Hereinafter, the training unit 21 extracts n (n is an integer of N or less) records from the data group D1, and the label accuracy calculation unit 22 extracts m (m is an integer of N or less) records from the data group D1.

After completion of machine learning of the label predictor by the training unit 21, the label accuracy calculation unit 22 extracts m sets of the sample and the label from the data group D1, and calculates the label accuracy P for each extracted set. Specifically, the label accuracy calculation unit 22 acquires a predicted label output by the label predictor by inputting the extracted sample to the label predictor configured with reference to the label predictor information D2. Then, the label accuracy calculation unit 22 calculates the label accuracy P according to a difference between the predicted label and an actual label related to the input sample. The label accuracy P is set to a smaller value as the difference between the predicted label and the actual label is larger. The label accuracy P is, for example, an L1 distance between the predicted label and the actual label. In a case where the predicted label is “y” and the actual label is“y\hat{ }”, the label accuracy P is defined as “exp (−|y-y\hat{ }|)”. The label accuracy P may be an L2 distance between the predicted label and the actual label, may be a cross entropy, or may be a value obtained by subtracting cosine similarity between the predicted label and the actual label from 1. Hereinafter, it is assumed that the label accuracy P is a value of 0 to 1 according to the difference between the predicted label and the actual label.

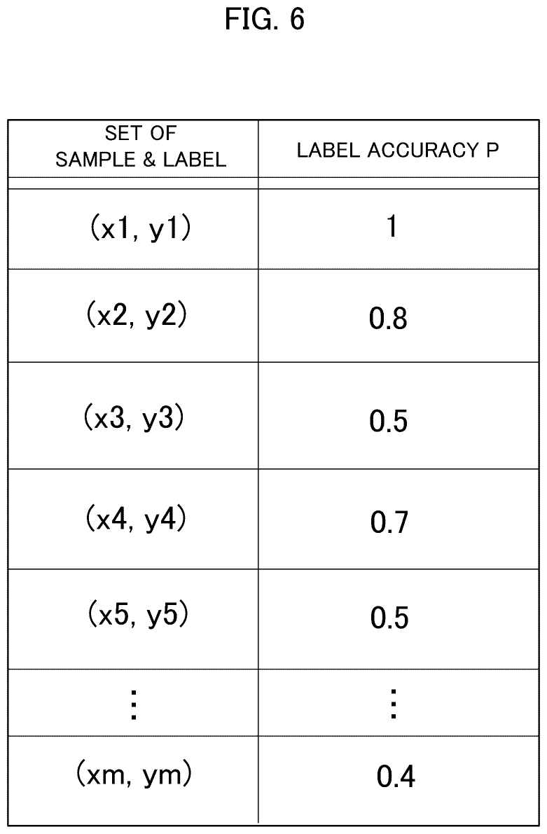

FIG. 6 is a table illustrating association between a set of a sample and a label and the label accuracy P. Here, the label accuracy calculation unit 22 extracts m sets of the sample and the label from the data group D1, and calculates the label accuracy P of each of the m sets. In FIG. 6, the sample is represented by {x1, x2, x3, x4, x5, . . . , and xm}, and the related label is represented by {y1, y2, y3, y4, y5, . . . , and ym}. The label accuracy P falls within a value range of 0 to 1, and the label accuracy P with respect to (x1, y1) has a maximum value of 1. Hereinafter, the label accuracy P related to (x1, y1), (x2, y2), (x3,y3), (x4, y4), (x5, y5), . . . , and (xm, ym) is denoted as {p1, p2, p3, p4, p5, . . . , and pm}.

Processing executed by the data selection unit 23 will be described with reference to FIG. 5 again. The data selection unit 23 selects a set of a sample and a label to be used for generating pseudo data, based on the label accuracy P calculated by the label accuracy calculation unit 22. For example, the data selection unit 23 probabilistically samples a set of a sample and a label used for generating pseudo data from m sets of the sample and the label, based on the label accuracy P.

For example, in a case where an index i (i=1, . . . , and m) representing any set of a sample and a label is used, the data selection unit 23 samples a set of a sample and a label (xi, yi) with the following probability according to the related label accuracy P (here, pi).

$$pi / ( p 1 + … + pm )$$

Then, the data selection unit 23 supplies the selected set of the sample and the label to the data generation unit 24. Hereinafter, it is assumed that the data selection unit 23 selects M (M is an integer of m or less) sets of the sample and the label.

The data selection unit 23 may correct the label accuracy P lower than a predetermined threshold to 0 and adjust probability of sampling to 0. As a result, the data selection unit 23 reliably suppresses selection of a set of a sample and a label with a low reliability label. The above described threshold may be a predetermined value, or may be set to a value that a predetermined ratio of lower label accuracy P falls below.

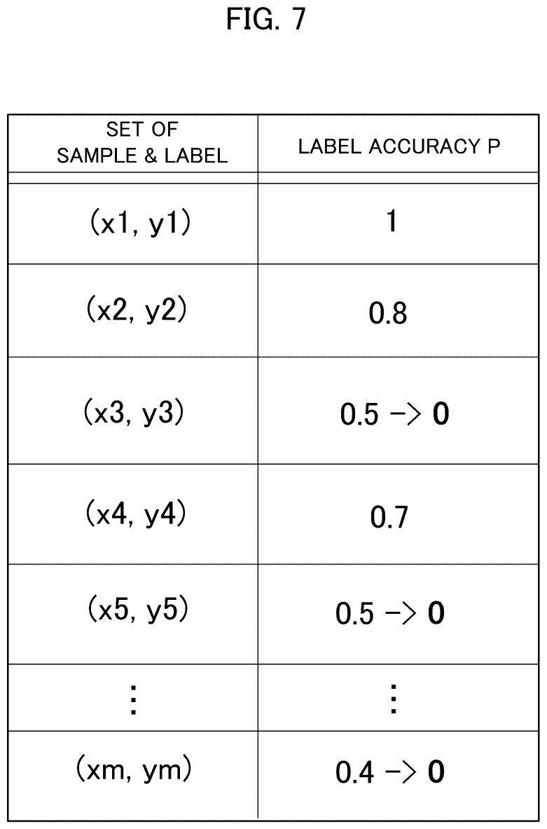

FIG. 7 illustrates a specific example of correction of the label accuracy P. In this example, the data selection unit 23 sets the threshold to 0.6 and corrects the label accuracy P lower than 0.6 to 0. Therefore, the data selection unit 23 sets the label accuracy P of each of (x3, y3), (x5, y5), (xm, ym), and the like in which the label accuracy P is lower than 0.6 to 0. As a result, the data selection unit 23 can set probability that these sets of the sample and the label whose label accuracy P is lower than the threshold are selected to 0.

Processing executed by the data generation unit 24 will be described with reference to FIG. 5 again. The data generation unit 24 generates pseudo data, based on M sets of the sample and the label supplied from the data selection unit 23. In this case, the pseudo data is a set of a pseudo sample and a pseudo label related to the pseudo sample. For example, the data generation unit 24 randomly selects any two sets (xv, yv) and (xw, yw) from the M sets of the sample and the label selected by the data selection unit 23, and generates a pseudo sample obtained by linearly interpolating the selected samples xv and xw and a pseudo label obtained by linearly interpolating the labels yv and yw. In this case, when λ is a hyperparameter of 0 to 1 or a randomly sampled value, the pseudo sample and the pseudo label are calculated as follows.

$$λ xv + ( 1 - λ ) xw$$

$$λ yv + ( 1 - λ ) yw$$

The data generation unit 24 may generate a pseudo sample and a pseudo label using any algorithm that integrates two pieces of data, not limited to the above described linear interpolation. In a case where time series lengths of samples are not uniform, the data generation unit 24 may perform processing of converting each sample to unify the time series lengths of the samples. For example, the data generation unit 24 specifies a time series length of a sample having the maximum time series length, and interpolates (for example, linearly interpolates) each sample in a time axis direction in such a way that all the samples have the specified time series length.

Then, the data generation unit 24 generates a predetermined number of pieces of pseudo data by repeating selection of any two sets of the sample and the label selected by the data selection unit 23 and generation of a pseudo sample and a pseudo label any number of times.

Here, each component of the training unit 21, the label accuracy calculation unit 22, the data selection unit 23, and the data generation unit 24 can be implemented by, for example, the processor 11 executing a program. Each component may also be achieved by recording a necessary program in an optional nonvolatile storage medium and installing the program as necessary. At least a part of these components is not limited to be achieved by software by a program, and may be achieved by a combination of any of hardware, firmware, and software, or the like. At least a part of these components may be achieved using, for example, a user-programmable integrated circuit such as a field-programmable gate array (FPGA) or a microcontroller. In this case, a program including the above components may be achieved by using the integrated circuit. At least a part of the components may include an application specific standard produce (ASSP), an application specific integrated circuit (ASIC), or a quantum processor (quantum computer control chip). In this manner, the components may be achieved by various types of hardware. The same applies to other example embodiments described later. These components may also be achieved by, for example, cooperation of a plurality of computers by using a cloud computing technology or the like.

### (4) Processing Flow

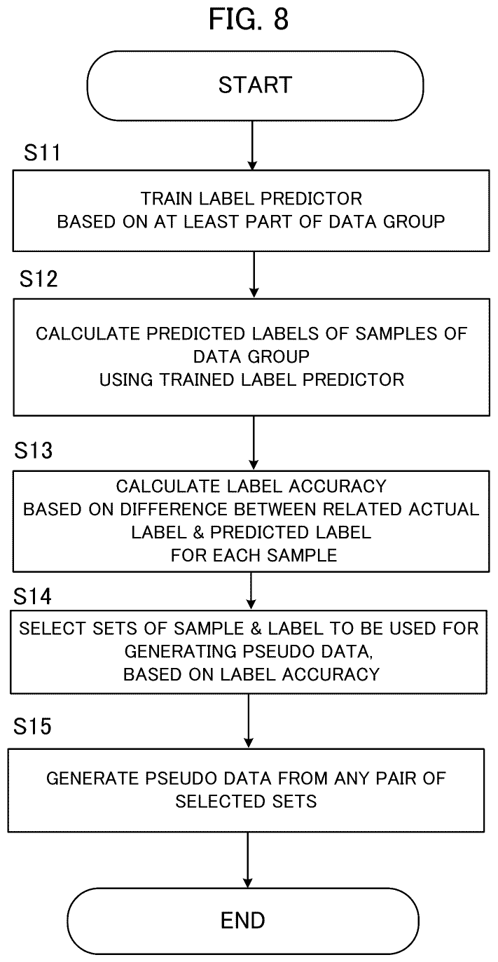

FIG. 8 is an exemplary flowchart to be executed by the pseudo data generation device 1.

First, the pseudo data generation device 1 trains the label predictor, based on at least a part of the data group D1 (step S11). In this case, the pseudo data generation device 1 determines a parameter of the label predictor using n sets of the sample and the label. As a result, the pseudo data generation device 1 generates the label predictor information D2 including the parameter of the label predictor on which machine learning has been performed.

Then, the pseudo data generation device 1 calculates a predicted label of a sample of the data group D1 using the trained label predictor (step S12). In this case, the pseudo data generation device 1 acquires m sets of the sample and the label, and calculates a predicted label of each of the m samples using the label predictor.

Next, the pseudo data generation device 1 calculates the label accuracy P based on a difference between a related actual label and the predicted label for each of the m samples for which the predicted labels have been calculated (step S13). Then, the pseudo data generation device 1 selects a set of a sample and a label used for generating pseudo data, based on the label accuracy P (step S14). For example, the pseudo data generation device 1 selects M sets of the sample and the label used for generating pseudo data by sampling with probability based on the label accuracy P.

Then, the pseudo data generation device 1 generates pseudo data based on any two sets from the M sets of the sample and the label selected in step S14 (step S15). The pseudo data generation device 1 generates a predetermined number of pieces of pseudo data by repeat processing of selecting the two sets from the M sets of the sample and the label, and generating pseudo data from the selected two sets a predetermined number of times.

### (5) Application Example

According to the above described example embodiment, it is possible to perform data augmentation of training data for machine learning of a machine learning model applicable to a healthcare field and the like and perform machine learning of a machine learning model capable of outputting a highly accurate inference result. For example, data augmentation of training data available for machine learning of a correct/incorrect motion determination model that outputs a correct/incorrect inference result of rehabilitation exercise in a case where video data of the rehabilitation exercise is input can be performed. Then, by using the inference result output by the correct/incorrect motion determination model for which the machine learning has been performed with high accuracy using the data-augmented training data, it is possible to suitably support decision-making of a medical worker such as a doctor and a nurse, regarding rehabilitation instruction to a patient. As described above, the present example embodiment is suitably applied to, for example, data augmentation of training data of a machine learning model that outputs an inference result that can be used for decision-making of a medical worker in a healthcare field.

### (6) Modification

Next, modifications suitable for the above described example embodiment will be described. The following modifications may be applied to the above described example embodiment in any combination.

### Modification 1

A storage device 2 may store in advance a label predictor related to a label predictor on which machine learning has already been performed. In this case, a pseudo data generation device 1 may not perform processing of executing machine learning of the label predictor.

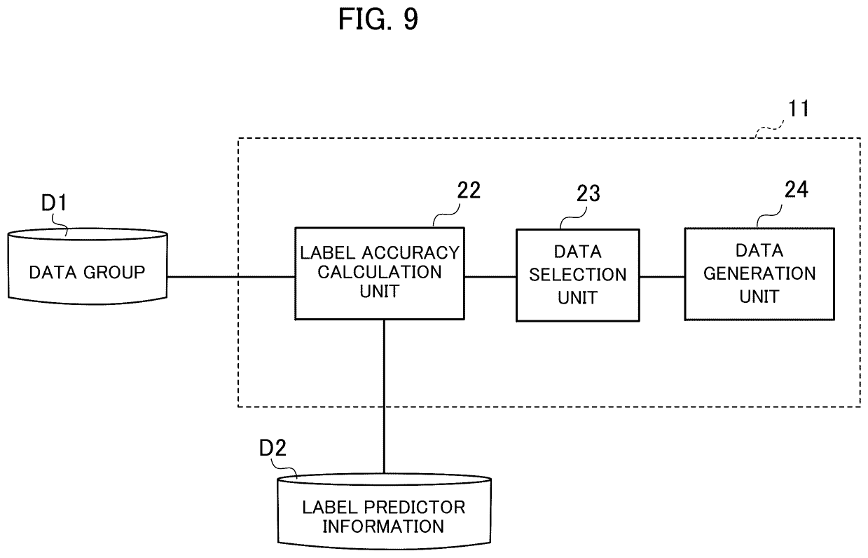

FIG. 9 is an example of functional blocks of a processor 11 of the pseudo data generation device 1 that does not perform machine learning of the label predictor. The processor 11 of the pseudo data generation device 1 functionally includes a label accuracy calculation unit 22, a data selection unit 23, and a data generation unit 24.

In the present modification, machine learning of the label predictor is performed by a device other than the pseudo data generation device 1, and label predictor information D2 including a parameter of the label predictor obtained by machine learning is stored in the storage device 2.

The label accuracy calculation unit 22 acquires a set of a sample and a label from a data group D1, and calculates a predicted label of the acquired sample using the machine-learned label predictor configured with reference to the label predictor information D2. Then, the label accuracy calculation unit 22 calculates label accuracy P indicating a difference between the calculated predicted label and an actual label for each sample. The data selection unit 23 selects a set of a sample and a label to be used for pseudo data, based on the label accuracy P calculated by the label accuracy calculation unit 22, and the data generation unit 24 generates pseudo data, based on the selected set of the sample and the label.

As described above, the pseudo data generation device 1 can suitably generate pseudo data even when the label predictor on which machine learning has been performed in advance is used.

### Modification 2

The sample included in the data group D1 is not limited to the time-series data representing the motion. For example, the sample may be any time-series data, or may be data other than the time-series data (for example, still images or data other than images). Similarly, the label related to each sample is not limited to the label indicating the correctness or incorrectness of the motion, and may indicate the classification (class) of the sample.

### Second Example Embodiment

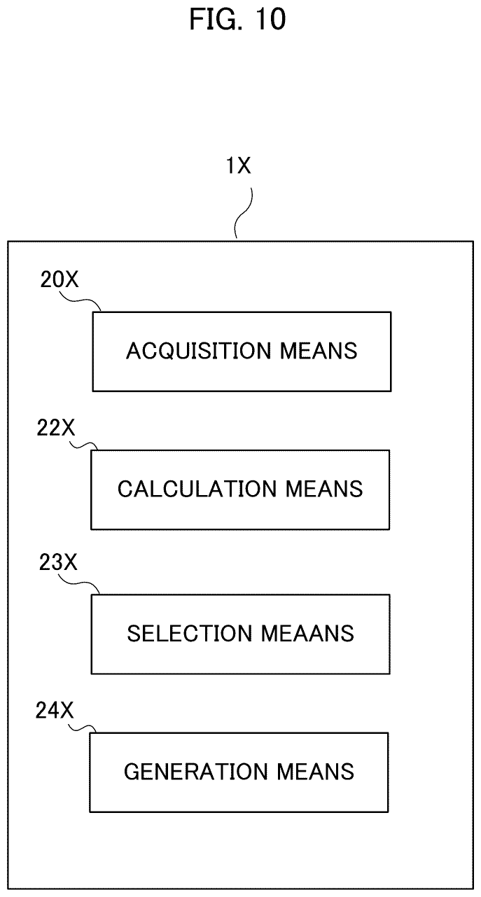

FIG. 10 is an example of a block diagram of the information processing device 1X. The information processing device 1X includes an acquisition means 20X, a calculation means 22X, a selection means 23X, and a generation means 24X. Examples of the information processing device 1X include the pseudo data generation device 1 according to the first example embodiment.

The acquisition means 20X is configured to acquire a plurality of sets each including a sample and a label. The calculation means 22X is configured to calculate, for each of the plurality of sets, accuracy of the label based on a difference between the label and a predicted result of the label predicted from the sample paired with the label. Examples of the acquisition means 20X and the calculation means 22X include the label accuracy calculation unit 22 according to the first example embodiment.

The selection means 23X is configured to select a set to be used for generating pseudo data from the plurality of sets, based on the accuracy. Examples of the selection means 23X include the data selection unit 23 according to the first example embodiment.

The generation means 24X is configured to generate the pseudo data, based on the selected set. Examples of the generation means 24X include the data generation unit 24 according to the first example embodiment.

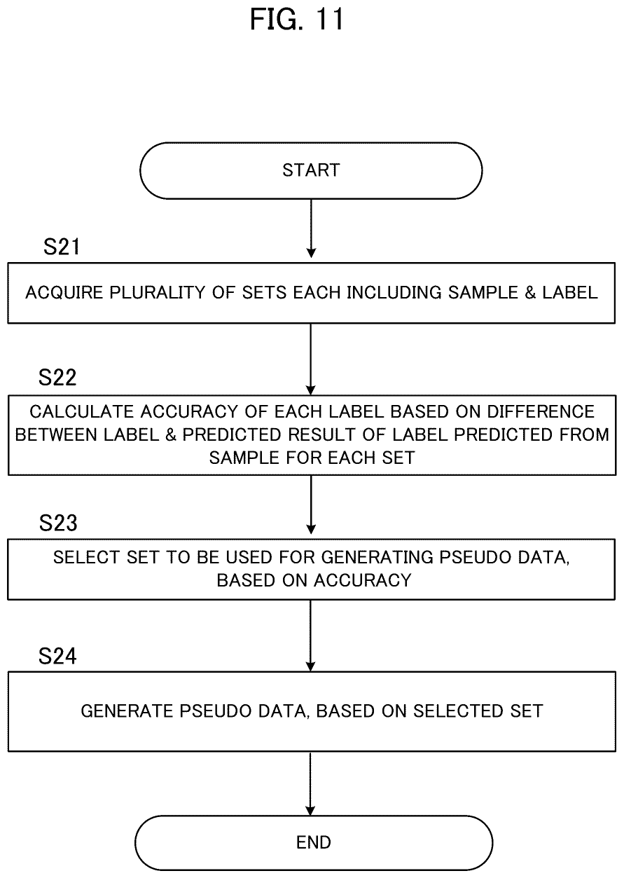

FIG. 11 illustrates an example of the flowchart of the process executed by the information processing device 1X. The acquisition means 20X acquires a plurality of sets each including a sample and a label (step S21). The calculation means 22X calculates, for each of the plurality of sets, accuracy of the label based on a difference between the label and a predicted result of the label predicted from the sample paired with the label (step S22). The selection means 23X is configured to select a set to be used for generating pseudo data from the plurality of sets, based on the accuracy (step S23). The generation means 24X is configured to generate the pseudo data, based on the selected set (step S24).

The information processing device 1X according to the second example embodiment can generate pseudo data with a high degree of reliability by selecting a set of a sample and a label based on the accuracy of the label.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

In addition, some or all of the above-described example embodiments may also be described as following Supplementary Notes, but are not limited to the following. A part of or all of configuration described in in the following Supplementary Notes 2 to 9 depending on the following Supplementary Note 1 can be dependent on Supplementary Notes 10 and 11 in the same manner. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### Supplementary Note 1

An information processing device comprising:
an acquisition means for acquiring a plurality of sets each including a sample and a label;
a calculation means for calculating, for each of the plurality of sets, accuracy of the label based on a difference between the label and a predicted result of the label predicted from the sample related to the label;
a selection means for selecting a set to be used for generating pseudo data from the plurality of sets, based on the accuracy; and
a generation means for generating the pseudo data, based on the selected set.

### Supplementary Note 2

The information processing device according to Supplementary Note 1, wherein the calculation means acquires the predicted result, based on a predictor that has learned, through a machine learning, a relationship between the sample and the label predicted from the sample.

### Supplementary Note 3

The information processing device according to Supplementary Note 2, further comprising
a training means for determining parameters of the predictor through the machine learning based on the plurality of sets or a set of a sample and a label other than the plurality of sets, wherein
the calculation means acquires the predicted result, based on the predictor trained through the machine learning.

### Supplementary Note 4

The information processing device according to Supplementary Note 1, wherein the selection means selects the set by sampling with probability according to the accuracy.

### Supplementary Note 5

The information processing device according to Supplementary Note 4, wherein the selection means sets the probability of sampling the set of the sample and the label whose accuracy is equal to or less than a predetermined threshold to 0.

### Supplementary Note 6

The information processing device according to Supplementary Note 1, wherein
the plurality of sets are training data used for machine learning of an artificial intelligence model that outputs information used for supporting decision making, and
the pseudo data is the training data generated by data augmentation of the plurality of sets.

### Supplementary Note 7

The information processing device according to Supplementary Note 1, wherein the calculation means sets the accuracy that decreases as the difference increases.

### Supplementary Note 8

The information processing device according to Supplementary Note 1, wherein
the sample is data representing a sequence of motions at respective time steps and
the label is data indicating correctness or incorrectness of the sequence of motion represented by the sample paired with the label.

### Supplementary Note 9

A method executed by a computer, comprising:
acquiring a plurality of sets each including a sample and a label;
calculating, for each of the plurality of sets, accuracy of the label based on a difference between the label and a predicted result of the label predicted from the sample paired with the label;
selecting a set to be used for generating pseudo data from the plurality of sets, based on the accuracy; and
generating the pseudo data, based on the selected set.

### Supplementary Note 10

A program executed by a computer, the program causing the computer to:
acquire a plurality of sets each including a sample and a label;
calculate, for each of the plurality of sets, accuracy of the label based on a difference between the label and a predicted result of the label predicted from the sample paired with the label;
select a set to be used for generating pseudo data from the plurality of sets, based on the accuracy; and
generate the pseudo data, based on the selected set.

### Supplementary Note 11

A storage medium storing the program according to Supplementary Note 10.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1 Pseudo data generation device
1X Information processing apparatus
2 Storage device
3 Display device
4 Input device
11 Processor
12 Memory
13 Interface
100 Pseudo data generation system

1. An information processing device comprising:
at least one memory configured to store instructions, and
at least one processor configured to execute the instructions to:
acquire a plurality of sets each including a sample and a label;
calculate, for each of the plurality of sets, accuracy of the label based on a difference between the label and a predicted result of the label predicted from the sample paired with the label;
select a set to be used for generating pseudo data from the plurality of sets, based on the accuracy; and
generate the pseudo data, based on the selected set.

2. The information processing device according to claim 1, wherein the at least one processor is configured to execute the instructions to acquire the predicted result, based on a predictor that has learned, through a machine learning, a relationship between the sample and the label predicted from the sample.

3. The information processing device according to claim 2, wherein
the at least one processor is configured to further execute the instructions to
determine parameters of the predictor through the machine learning based on the plurality of sets or a set of a sample and a label other than the plurality of sets, wherein
acquire the predicted result, based on the predictor trained through the machine learning.

4. The information processing device according to claim 1, wherein the at least one processor is configured to execute the instructions to select the set by sampling with probability according to the accuracy.

5. The information processing device according to claim 4, wherein the at least one processor is configured to execute the instructions to set the probability of sampling the set of the sample and the label whose accuracy is equal to or less than a predetermined threshold to 0.

6. The information processing device according to claim 1, wherein
the plurality of sets are training data used for machine learning of an artificial intelligence model that outputs information used for supporting decision making, and
the pseudo data is the training data generated by data augmentation of the plurality of sets.

7. The information processing device according to claim 1, wherein the at least one processor is configured to execute the instructions to set the accuracy that decreases as the difference increases.

8. The information processing device according to claim 1, wherein
the sample is data representing a sequence of motions at respective time steps and
the label is data indicating correctness or incorrectness of the sequence of motion represented by the sample paired with the label.

9. A method executed by a computer, comprising:
acquiring a plurality of sets each including a sample and a label;
calculating, for each of the plurality of sets, accuracy of the label based on a difference between the label and a predicted result of the label predicted from the sample paired with the label;
selecting a set to be used for generating pseudo data from the plurality of sets, based on the accuracy; and
generating the pseudo data, based on the selected set.

10. A non-transitory computer readable storage medium storing a program executed by a computer, the program causing the computer to:
acquire a plurality of sets each including a sample and a label;
calculate, for each of the plurality of sets, accuracy of the label based on a difference between the label and a predicted result of the label predicted from the sample paired with the label;
select a set to be used for generating pseudo data from the plurality of sets, based on the accuracy; and
generate the pseudo data, based on the selected set.
